(19) United States
(12) Patent Application Publication
(10) Pub. No.: US 2003/0039175 A1
(43) Pub. Date: Feb. 27, 2003

(54) Portable, hands-free mechanical timers for alerting tasks and method for using same

(76) Inventor: Stacey Beth Gold, Tarzana, CA (US)

Correspondence Address: STOUT, UXA, BUYAN & MULLINS LLP, 4 VENTURE, SUITE 300, IRVINE, CA, 92618, US

(21) Appl. No.: 09/938,872

(22) Filed: Aug. 24, 2001

(51) Int. Cl. G04F 1/00; G04F 3/00

(52) U.S. Cl. 368/97

(57) ABSTRACT

A portable, hands-free mechanical timer to be worn and preset by a user for a predetermined period of time and for counting down to zero in order to alert the user of the time remaining for performing a specific task is disclosed. Also disclosed are methods for using the portable, hands-free mechanical timer, especially by hairdressers.

### FIELD OF THE INVENTION

This invention relates to timers and methods for using them to determine elapsed time and the time remaining for performing a task, and to alert the user as to the task to be performed at the end of the elapsed time.

### BACKGROUND OF THE INVENTION

Timers that countdown from a predetermined amount of time are known. These timers include conventional mechanical kitchen timers and digital battery operated watches are known in the art.

### SUMMARY OF THE INVENTION

The present invention presents an easy to read, easy to use, easy to wear, and cost efficient timer, which is constructed to be portable and to facilitate hands-free operation. The portable, hands-free mechanical timer can be pre-set by a user for a predetermined time period to remind her to perform a given task at the end of the predetermined time period. The portable, hands-free mechanical timer starts at a preset time period and counts downwardly until it reaches zero. The portable, hands-free mechanical timer visually displays, in a very effective and convenient way, the time remaining until the task is to be performed. In addition, the portable, hands-free mechanical timer preferably possesses means for producing an audible signal upon expiration of the preset time period, thus indicating to the user that the time to perform the task has arrived. In particular, the portable, hands-free mechanical timer of the present invention may be worn by a hairdresser to alert her of the appropriate time at which to apply or to remove any hair treatment from a customer's hair. Also, the portable, hands-free mechanical timer may be worn by a user to alert her of an expiration of a cooking-time period for her food. The portable, handsfree mechanical timer can alert the user even when she is away from the kitchen. Other features, advantages, and uses of the present invention will become readily apparent from the following detailed description, appended drawings, and accompanying claims.

### DETAILED DESCRIPTION OF THE DRAWINGS

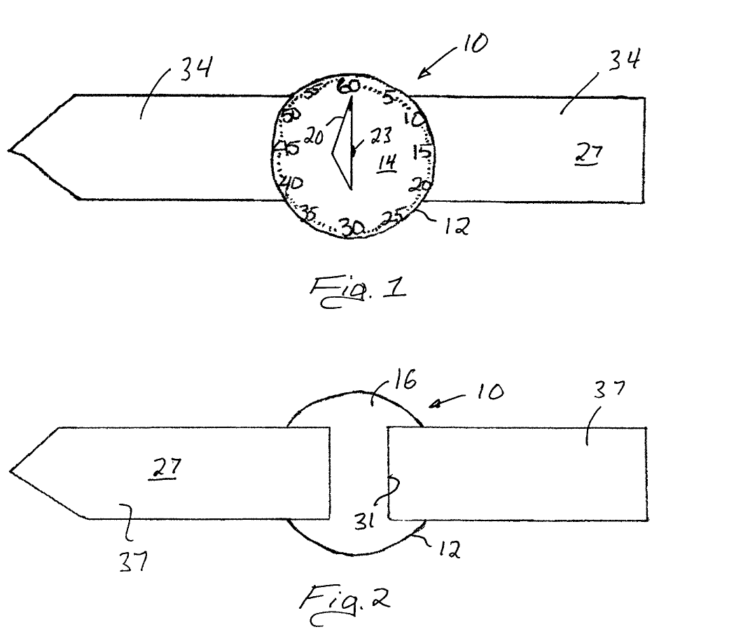

FIG. 1 illustrates a top planar view of a portable, hands-free mechanical timer in accordance with a first presently preferred embodiment;

FIG. 2 is a bottom planar view of the portable, hands-free mechanical timer of FIG. 1;

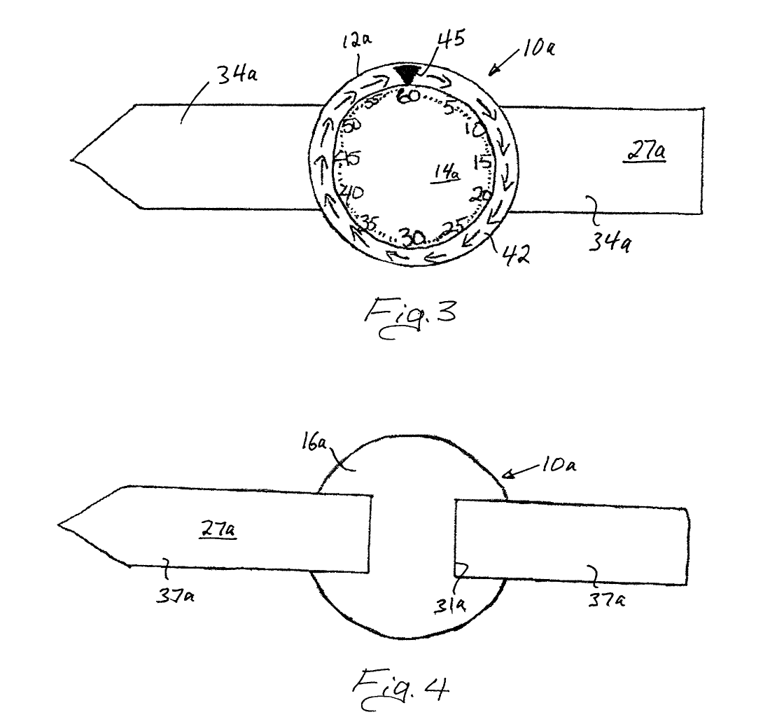

FIG. 3 illustrates a top planar view of a portable, hands-free mechanical timer in accordance with a second presently preferred embodiment;

FIG. 4 is a bottom planar view of the portable, hands-free mechanical timer of FIG. 3;

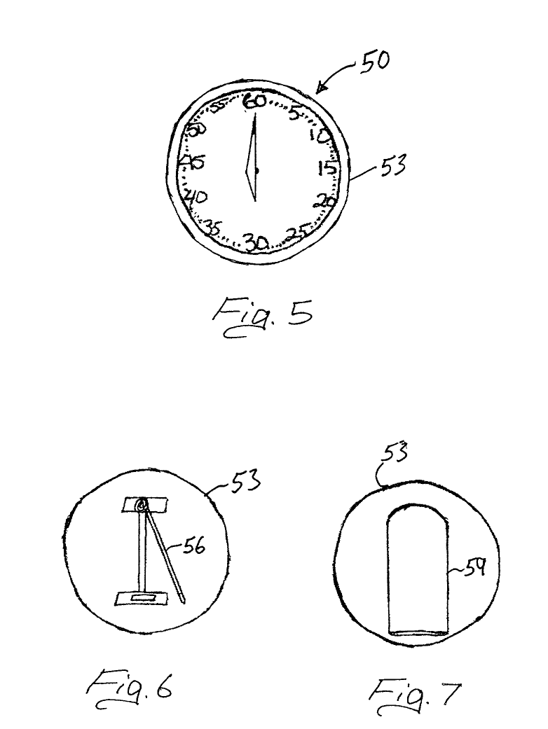

FIG. 5 illustrates a top planar view of a portable, hands-free mechanical timer in accordance with another construction;

FIG. 6 is a bottom planar view of the portable, hands-free mechanical timer of FIG. 5 in accordance with a broach or breast-pin embodiment of the present invention; and

FIG. 7 is a bottom planar view of the portable, hands-free mechanical timer of FIG. 5 in accordance with a belt-clip embodiment of the present invention.

### DETAILED DESCRIPTION OF THE PRESENT INVENTION

The present inventor has discovered a portable, hands-free mechanical timer, which is formed of a simple and convenient construction to be carried on a user and which is easy to use and understand, thus reducing the possibility of erroneous operation. The portable, hands-free mechanical timer can be carried by the user in a hands-free manor for timing and for reminding the user to perform a task. When the portable, hands-free mechanical timer is secured to the user, the user may move about with both hands free for performing various tasks. Moreover, and of particular importance, the portable, hands-free mechanical timer can be set and activated with only a single hand of the user, thus rendering the other hand free to perform other tasks, when the portable, hands-free mechanical timer is secured to the user. Valuable time will be saved as a result of the user always knowing exactly where the portable, hands-free mechanical timer is and always knowing exactly which hand will be needed to be used to activate the portable, hands-free mechanical timer. In the busy and hustled context of a beauty salon, for example, the likelihood that such timers will be mistakenly misplaced or swapped by users is substantially reduced.

Accordingly, the present invention provides such portable, handsfree mechanical timers and methods for using them. The present invention relates generally to portable, hands-free mechanical timers that alert users of tasks to be performed particularly, for example, in the contexts of hairdressing and cooking. This invention provides a portable, hands-free mechanical timer by which the user is alerted, upon the expiration of a predetermined time period that is preset on the timer by the user, that a task is to be performed. More particularly, this invention provide a portable, hands-free mechanical timer that enables the user to rapidly and reliably determine the amount of time, e.g., in minutes, remaining until one or more given tasks are to be performed. The mechanical dial setting of the portable, hands-free mechanical timer provides an intuitive aspect to time keeping, wherein the user can see visually the amount of time remaining. Additionally, the portable, hands-free mechanical timer preferably possesses means for producing an audible signal upon expiration of the preset time period, thus indicating to the user that it is time to perform the task.

For convenience, the following describes the use of the portable, hands-free mechanical timer in the context of the hair care industry, and the user is thus described as the hairdresser; and for the purpose of hair care and in accordance with the illustrated embodiments the portable, hands-free mechanical timer measures a maximum time period of one hour. However, aspects of this invention may be used by different users in connection with various other areas of endeavor requiring tasks to be performed on fixed intervals, and the portable, hands-free mechanical timer is designed to measure the time period for a particular endeavor and may therefore measure a time period other than an hour. In modified embodiments, the portable, hands-free mechanical timer of the present invention may have second or hour markings, in addition to or as an alternative to the minute indicia shown on the figures and/or “dial” and “pointer” displays, e.g., both items animated on an LCD. An example of the other endeavor is cooking or assembly-line construction. The portable, hands-free mechanical timer may be worn on a user to alert the user of, for example, the time left or the due time for a cooking or assembling task.

This invention is particularly directed to portable, hands-free mechanical timers, which are adapted for use by hairdressers in connection with the servicing of hair care customers. The portable, hands-free mechanical timers are particularly useful because hairdressers tend to lose count of their time. Due to the different application times of hair treatment products, such as hair coloring, hair perming and hair care solutions, time keeping is a task which is often misapplied or forgotten. The portable, hands-free mechanical timer is carried on the hairdresser's person, such that the hairdresser can quickly assess the amount of time remaining, in minutes, for a particular hair coloring procedure or process, thereby facilitating time management for the hairdresser, especially for a professional hairdresser.

The portable, hands-free mechanical timer may be removably secured around the hairdresser's wrist or arm using the embodiments of FIGS. 1-4, or may be removably secured to her clothing, neck and/or accessories using, for example, the constructions of FIGS. 5-7. The hairdresser may selectively set the portable, hands-free mechanical timer as required to thereby provide her with an audible signal (such as an alarm signal) indicative of the expiration of a predetermined time period preset by her. The time period display provides quick and ready access to the time remaining in the predetermined set time period in a manner facilitating time management. A hairdresser may wear one portable, hands-free mechanical timer to remind her of a task to be performed on a hair care customer, or she can wear several portable, hands-free mechanical timers to remind her of tasks to be performed on several hair care customers.

Referring more particularly to the drawings, FIGS. 1 and 2 present a non-limiting example of a presently preferred portable, hands-free mechanical timer of the invention, in which the portable, hands-free mechanical timer 10 resembles a wristwatch in size and is constructed to be worn on the wrist of the hairdresser. The portable, hands-free mechanical timer 10 comprises a body 12 having a dial 14 and a back surface 16. Indicia are disposed about the circumferential periphery of the dial 14, preferably in five-minute increments. A pointer 20 is disposed on a central portion of the front face, and is rotatable about the central point 23 in a clockwise direction. A user can move the pointer 20 in the clockwise direction to set the portable, hands-free mechanical timer 10 to any time period in a range from one to sixty minutes. Once released, the pointer 20 will move in the counter-clockwise direction back to the position shown, at which time an audible indication will be delivered indicating that the pre-set time has elapsed. The pointer 20 is preferably spring-biased but may, in accordance with a modified embodiment, by biased by other means such as a battery in addition to or as an alternative to the spring-biasing. A wristband 27 is secured to the body 12 in the illustrated embodiment.

As illustrated in FIG. 2, the back surface 16 of the portable, hands-free mechanical timer 10 comprises a slot 31 for accommodating the wristband 27 therethrough. Thus, the hairdresser can wear different portable, hands-free mechanical timers with different colored wristbands to thereby identify the different time-tracking projects corresponding to, for example, different customers. In another embodiment, the portable, hands-free mechanical timers are provided in various colors to match the colored wristbands. In yet another embodiment, the wristbands are all one color and the portable, hands-free mechanical timers are provided in various colors. In still another modified embodiment, the portable, hands-free mechanical timers are provided in a single color but are provided with face plates of various colors that can be interchangeably attached to the portable, hands-free mechanical timers. Preferably, the wristband has an easily detachable design to enable it to be easily detachable from the user or to be adjustable to different user sizes. For example, the wristband may comprise a hook-and-loop (e.g., Velcro™) material alone or in combination with a suitable closure, buckle, clasp closure or any other form of closure that is conventionally used on wristwatches. In the illustrated embodiment, the wristband 27 comprises a distribution of loops on the top surface 34 and a distribution of hooks on the bottom surface 37. In a modified embodiment, the wristband 27 comprises a distribution of hooks on the top surface 34 and a distribution of loops on the bottom surface 37. As presently embodied, the wristband comprises a width of about one-half inch (or any other convenient width) an appropriate length so that it can be a “one size fits all” wristband. It is found that a wristband of about 8 inches long will meet such a “one size fits all” length.

Application times of hair products are usually one hour or less. Thus, the maximum time on the portable, hands-free mechanical timer 10 need only be one hour, and thus the portable, hands-free mechanical timer 10 need only display and count in minutes in the illustrated embodiments. Other time periods and increments may be implemented in modified embodiments. Similarly to a conventional wristwatch, the portable, hands-free mechanical timer 10 can be of any shape and size. In FIGS. 1-4, the portable, hands-free mechanical timer is preferably circular and relatively flat (like a wristwatch) with a diameter that will preferably allow for the markings of the time (in minutes) to be large enough to ensure that a user can, at a glance, easily recognize the displayed time period without significant cognitive thought. A diameter of between about 0.5 to 1 inch is preferably implemented to meet this criteria. As shown in FIG. 1, the rotatable pointer is preferably large enough for the hairdresser to grasp so she can turn it to preset the portable, hands-free mechanical timer to her desired predetermined time period. In the exemplary embodiment of FIGS. 1 and 2, the rotatable pointer resembles and operates similarly to a conventional spring-loaded kitchen timer, such as the Lux Minute Minder Kitchen Timer 8847 sold by Jensco, Inc. of East Glastonbury, Conn. Alternatively, the portable, hands-free mechanical timer 10 can be battery operated. In yet another modified embodiment, the configuration of FIG. 3 may be implemented (visually represented) on a LCD display to simulate the appearance and functionality of the FIG. 1 embodiment. The LCD display preferably comprises a circular perimeter and, more preferably, is similar or even substantially identical in appearance (with simulated movement of the pointer) to the embodiments of FIGS. 1, 3 and 5.

The portable, hands-free mechanical timer 10 starts from the time preset by the hairdresser and then counts downward (counter-clockwise) until it reaches zero (i.e., sixty). That is, the rotatable pointer is seen to automatically count down (move) to zero from the predetermined time duration. For example, the rotatable pointer 20 may be preset at sixty minutes and, thereafter, it gradually counts down to zero. By glancing at the rotatable pointer 20 at any moment, the hairdresser can quickly discern the time remaining for performing a task. For example, the rotatable pointer 20 may be rotated so that it points to the forty-five minute mark to preset the time that a task is to be performed at the end of forty-five minutes. The rotatable pointer 20 then rotates in the counterclockwise direction and counts down to zero. As shown in FIG. 1, when zero minutes remain, the rotatable pointer will point to the sixty minute mark in the illustrated embodiment.

Preferably, the portable, hands-free mechanical timer 10 includes means for producing an audible signal upon expiration of the preset time period set on the portable, hands-free mechanical timer 10, in order to alert the hairdresser that it is time for her to perform a task on her customer. For example, the portable, hands-free mechanical timer 10 may include an alarm unit to signal the conclusion of the preset interval time. Any conventional alarm unit may be used, such as those used in commercially available wristwatches, stopwatches, clocks, and kitchen timers. Since the portable, hands-free mechanical timer is compact, portable and simple, it (including its alarm unit) can be spring-loaded and therefore mechanically operated.

Since hairdressers work with water and liquid, the portable, hands-free mechanical timer 10 is preferably waterproof. Its dial 14 and rotatable pointer 20 are preferably resistant to water damage and its internal mechanism is preferably stored in a housing that is waterproof. The portable, hands-free mechanical timer 10 may be designed with the same or similar waterproofing features found in conventional waterproof wristwatches. In accordance with one embodiment, the portable, hands-free mechanical timer 10 is constructed to be water resistant using close-tolerance fits and/or gaskets and seals. In accordance with another embodiment, the portable, hands-free mechanical timer 10 is constructed to be waterproof (or water resistant) using a cover for its dial 14. In this embodiment, the portable, hands-free mechanical timer may have a design similar to a pocket watch in having a cover which can be opened by the hairdresser when she wishes to read the remaining time or to reach the minute hand to set the portable, hands-free mechanical timer. Preferably, the cover is made of a transparent material, such as plastic, so that the hairdresser need not open the cover to read the remaining time. The portable, hands-free mechanical timer 10 may be constructed to be water resistant or water proof using other structures that are known in the art.

FIGS. 3 and 4 illustrate top and back views, respectively, of a portable, hands-free mechanical timer 10a. In FIGS. 3 and 4, elements corresponding to those of FIGS. 1 and 2 are indicated with like reference numerals followed by an “a.” As shown in FIG. 3, the portable, hands-free mechanical timer 10a has a dial 14a with sixty minute marks corresponding to an hour. A pointer register ring 42 is provided around the dial 14a for rotation in a clockwise direction relative to the dial so as to preset the time. Namely, the time remaining for performing a task is indicated by an indicator mark 45 disposed on the pointer register ring 42. In the embodiment of FIG. 3, the pointer register ring 45 may be rotated in the clockwise direction so that the indicator mark 45 on the pointer register ring 42 is aligned with the sixty minute mark to preset the time so that a task can be performed at the expiration of the sixty minutes. The pointer register ring 42 can by manually rotated by hand to the predetermined time duration, and the pointer register ring will then automatically rotate in a counter-clockwise direction to thereby count down to zero from the predetermined time duration. The back of this portable, hands-free mechanical timer 10a is illustrated in FIG. 4 having the same construction as shown in FIG. 2. The pointer register ring 42 is preferably spring loaded to rotate in a counterclockwise fashion back to the zero (i.e., sixty) position. In modified embodiments, the pointer register ring 42 may be battery powered. In still further embodiments, the configuration of FIG. 3 may be implemented (animated) on a LCD display to simulate the appearance and functionality of the FIG. 1 embodiment on a circular LCD display. This portable, hands-free mechanical timer lOa may have the other features as described above, such as the waterproof features, colors, alarm units, and spring-loaded mechanisms described in connection with FIGS. 1 and 2, above. In accordance with one embodiment of the present invention, the portable, hands-free mechanical timers and wrist bands are manufactured of relatively inexpensive, disposable materials so that they can be sold in bulk. For example, the portable, hands-free mechanical timers and their associated wristbands/accessories can be sold in boxes of 10 units at discounted rates (e.g., $25 for the box).

Instead of moving the rotatable pointer of FIGS. 1 and 2 or the pointer register ring of FIGS. 3 and 4 by hand, a preset button may be provided for the hairdresser to adjust the rotatable pointer and pointer register ring, similarly to a user using a preset button on a conventional wristwatch to adjust the hand or hands of a watch.

In the embodiments of FIGS. 1-4, the portable, hands-free mechanical timers are designed to be worn like wristwatches. Alternatively, instead of resembling a wristband, the portable, hands-free mechanical timer's strap may be designed to be configured at various lengths for wearing on the user's arm, around her neck like a necklace, or looped around the waist belt or waist band of the user.

In yet another embodiment as illustrated in FIG. 5, a portable, hands-free mechanical timer 50 is constructed to have a body 53 similar to the body 12 or the body 12a of FIGS. 1-2, and 3-4, respectively, with the exception that the body 53 does not comprise structure for accommodating a wrist band. Instead, as illustrated in FIG. 6, the body 53 comprises a detachable pin 56 on its back, so that the hands-free mechanical timer 50 resembles a broach, to allow it to be hooked or pinned onto the pocket, clothing, waistband, wristband waist belt, or other accessories of the user. In another embodiment, as illustrated in FIG. 7, the body 53 comprises a hook or other clasp 59 on its back, for facilitating attachment to a waist belt or wristband, for example.

In other modified embodiments, the portable, hands-free mechanical timer may resemble a stopwatch to be worn around the neck. For example, similarly to a stopwatch, the portable, hands-free mechanical timer 50 may have a loop such that a ribbon, necklace, or strap may be passed through the loop, either detachably or permanently, so that the portable, hands-free mechanical timer 50 may be worn around the neck. Alternatively, any of the portable, hands-free mechanical timers described above, and in particular the embodiment of FIGS. 3 and 4, may be used like a pocket watch (i.e., being carried in the user's pocket). Alternatively, and as mentioned above, instead of having a mechanical dial and rotatable pointer to indicate time, the wristwatch of the above embodiments may comprise animated displays that simulate the appearance and movements described in the above Figures. Such a portable, hands-free mechanical timer may implement the mechanism of a conventional digital watch, such as a liquid crystal display (LCD), a printed circuit board and battery to power the portable, hands-free simulated timer display and functionality. The portable, hands-free mechanical timer is preferably constructed to have the waterproof feature and alarm unit found in conventional digital wristwatches.

Thus, there has been described numerous modifications and variations which can be effected without departing from the true spirit and scope of the novel concept of the present invention. It will be appreciated that the present disclosure is intended as exemplifications of the invention, and is not intended to limit the invention to the specific embodiment illustrated. Thus, the concepts of this invention could be used for other situations in which timed reminders would be valuable. In its broadest aspects, the invention could be used whenever convenient portable, hands-free mechanical timers are required.

1. A portable, hands-free mechanical timer comprising:
a body having a first surface and a second surface opposite the first surface;
a dial disposed on the first surface of the body, the dial comprising a plurality of marks disposed around a perimeter of the dial;
a rotating pointer in the center of the dial serving as an indicator; and
an attachment structure disposed on the second surface of the body, the
attachment structure being constructed to be attached to a watch band;
wherein the rotatable pointer can be preset by a user to a predetermined
time period on the dial, the rotatable pointer being configured so as to be moved to a zero position upon the elapse of the predetermined time period.

2. The portable, hands-free mechanical timer as set forth in claim 1, wherein:
the first surface comprises a display;
the dial is shown in the display when the display is on; and
the rotating pointer is shown on the display when the display is on.

3. The portable, hands-free mechanical timer as set forth in claim 1, wherein the rotating pointer is spring-driven.

4. The portable, hands-free mechanical timer as set forth in claim 1, wherein the attachment structure comprises a slot.

5. The portable, hands-free mechanical timer as set forth in claim 1, wherein the attachment structure comprises a hook.

6. The portable, hands-free mechanical timer as set forth in claim 1, wherein the attachment structure comprises a pin.

7. The portable, hands-free mechanical timer of claim 1, wherein:
the portable, hands-free mechanical timer includes an alarm for producing an audible signal upon expiration of the predetermined time period preset by the user; and
the plurality of marks comprises sixty marks representing sixty minutes.

8. The portable, hands-free mechanical timer of claim 1, wherein the body comprises a waterproof housing.

9. A portable, hands-free mechanical timer comprising:
a body having a first surface and a second surface opposite the first surface;
a dial disposed on the first surface of the body, the dial comprising a plurality of marks disposed around a perimeter of the dial;
a rotating pointer register ring disposed around the plurality of marks and
serving as an indicator; and
an attachment structure disposed on the second surface of the body, the
attachment structure being constructed to be attached to a watch band;
wherein the rotating pointer register ring can be preset by a user to a
predetermined time period on the dial, the rotating pointer register ring being configured so as to be moved to a zero position upon the elapse of the predetermined time period.

10. The portable, hands-free mechanical timer as set forth in claim 9, wherein:
the first surface comprises a display;
the dial is shown in the display when the display is on; and
the rotating pointer register ring is shown on the display when the display is on.

11. The portable, hands-free mechanical timer as set forth in claim 9, wherein the rotating pointer register ring is spring-driven.

12. The portable, hands-free mechanical timer as set forth in claim 9, wherein the attachment structure comprises a slot.

13. The portable, hands-free mechanical timer as set forth in claim 9, wherein the attachment structure comprises a hook.

14. The portable, hands-free mechanical timer as set forth in claim 9, wherein the attachment structure comprises a pin.

15. The portable, hands-free mechanical timer of claim 9, wherein:
the portable, hands-free mechanical timer includes an alarm for producing an audible signal upon expiration of the predetermined time period preset by the user; and
the plurality of marks comprises sixty marks representing sixty minutes.

16. The portable, hands-free mechanical timer of claim 9, wherein the body comprises a waterproof housing.

17. A method of using a portable, hands-free mechanical timer of claim 1, the method comprising the following steps:
presetting the portable, hands-free mechanical timer for a predetermined time period for performing a task;
attaching the portable, hands-free mechanical timer onto a user;
carrying the portable, hands-free mechanical timer on the user, away from a location of the task;
allowing the portable, hands-free mechanical timer to count down to zero; and
performing the task when the portable, hands-free mechanical timer has counted down to zero.

18. The method of claim'7, wherein the task is a cooking task.

19. The method of claim'7, wherein the user is a hairdresser, and the task is for the hairdresser to apply or to remove a hair treatment product from a customer's hair.
